(19) United States
(12) Patent Application Publication
(10) Pub. No.: US 2020/0370340 A1
(43) Pub. Date: Nov. 26, 2020

(54) DOOR LOCK WITH IDENTIFICATION VERIFICATION SYSTEM

(71) Applicant: Jackie Fetchel Frahm, (US)

(72) Inventors: Jackie Fetchel Frahm, Indian Wells, CA (US); Joe Fetchel, Indian Wells, CA (US); William Jeffrey Schlanger, Palm Springs, CA (US); Bogdan Ryabyshchuk, Yucca Valley, CA (US)

(21) Appl. No.: 16/862,278

(22) Filed: Apr. 29, 2020

Related U.S. Application Data
(60) Provisional application No. 62/920,854, filed on May 20, 2019.

(51) Int. Cl. E05B 65/00; E05B 35/00

(52) U.S. Cl. CPC E05B 65/0042; E05B 35/007; E05B 35/001; E05Y 2600/526; E05Y 2400/66; E05Y 2800/426; E05Y 2900/102

(57) ABSTRACT

The system of the present invention is comprises of one or more door lock units, a data exchange system, and a clerk user interface. The door lock units are mounted to the cooler doors and prevent the doors from opening to allow access to the alcoholic products without authorization. These door lock units include a mechanical locking mechanism, an identification scanner/reader, and a display. The door lock units receives power from a power supply (with a back up power supply standing ready) and communicates wired or wirelessly with a data server and router combination. The data server and router combination also communicates with a clerk user interface, which may be in the form of a tablet, smart phone, laptop, or other computing device.

### CROSS-REFERENCES TO RELATED APPLICATIONS

This application claims priority from U.S. Application No. 62/920,854, filed May 20, 2019, incorporated by reference in its entirety.

### BACKGROUND

For many retail establishments, the greatest threat to profitability is theft. One of the industries that are hardest hit by consumer theft is retail stores that sell controlled substances, and the most ubiquitous controlled substance is alcohol sold in such as liquor stores, gas stations, mini markets, and the like. The reason for this phenomenon is well known: while the federal government and every state have an age limit in place to purchase alcoholic products, there are many underage persons who nonetheless have a fervent desire to obtain alcohol (preferably without paying for it). Because many alcoholic products are sold in containers that are easily concealed, theft of these products result in significant losses to such proprietors. To combat this crime, these types of establishments have sought out different tools to prevent theft, such as large parabolic mirrors, door alarms, video cameras, and similar measures to keep underage persons from accessing the liquor products.

One particularly common type of theft is beer theft. Known as “Beer Runs,” this act is a type of shoplifting that has been around for years. Typically, a person will enter a convenience store where there is a lone clerk behind the counter, pick up a single can, six pack, or even a case of beer and simply walk or run out the front door right past the clerk. This type of crime will often lead to a confrontational between the clerk and the suspect, increasing the potential for violence/damage/liability on the part of the store owner. Many clerks have been instructed to let the person leave the store without trying to stop them or recover the merchandise and to call the police after the person has left the store. This method reduces the likelihood of injury to the clerk, but increases the chance the business will be a repeat target for potential violence. These crimes can lead to additional crimes and risk the safety of store employees and customers, and stores can incur liability should the perpetrator commit other crimes.

Alcohol theft not only costs the retailer in lost product, but customers pay more at the cash register to make up for stolen merchandise. Stores can become known for being less safe, leading to fewer patronage. If a confrontation occurs, employees or customers could be injured or traumatized, and some stores becomes known on the street as an “easy mark” for criminals and an unsafe place to shop for honest customers. Therefore, this is a major problem affecting many stores of this kind.

Stores have tried to address this problem with mixed results. While mirrors and video cameras are helpful, store owners cannot spend all their time watching and monitoring such devices. Other patrons need to be attended to, and crafty thieves can defeat these measures with distractions and subterfuge. What is needed in the art is a more reliable method to keep underage patrons from the products while allowing appropriate patrons easily access to purchase such goods. The present invention is uniquely suited to solve this problem.

### SUMMARY OF THE INVENTION

The present invention is a door lock system and method that is suited for use with chilled compartments or “coolers” found in liquor stores and the like where alcoholic beverages are displayed and made available for purchase. Other doors or compartments can also benefit from the present invention where limited access to products are presented in stores, such as cannabis dispensaries, cigar shops, pharmaceutical products, and tobacco products. The door lock system is equipped with an identification reader that scans and verifies a government (state driver's license, military identification, etc.) personal identification card to verify age and permission to purchase alcohol. Information is read by the reader and sent to a server that confirms the information, checks for any restrictions or blocks, and if the person is approve the door is unlocked remotely by the remote control center. Information is also sent to a display, such as a tablet or computer screen that is preferably adjacent the clerk or store proprietor so that the clerk can see who is opening in the cooler to remove alcoholic products. The clerk can use this picture to make sure the person who unlocked the door is in fact the same person purchasing the alcoholic product. If the identification system deems that the would-be purchaser is not of proper age, the door remains locked and a message is sent to the clerk that an attempt has been made to access the cooler, for theft or for illegal purchase, so that the clerk can take appropriate measures.

The system also benefits the store owner by reducing the opportunity for selling alcohol (or other controlled products) to underage minors and incurring penalties from law enforcement. Additionally, intoxicated driving accidents involving minors can be reduced, and productivity can be increased because the need to constantly monitor the cooler is drastically reduced. These, and other features of the present invention will best be understood with reference to the accompanying figures in conjunction with the detailed description of the invention below.

### BRIEF DESCRIPTION OF THE DRAWINGS

FIG. 1 is a schematic diagram of a first embodiment of the present invention;

FIG. 2 is a schematic diagram of the remote control center connected to the clerk display unit and the door lock mechanisms;

FIG. 3 is a front view of the cooler door in the locked position;

FIG. 4 is a front view of the cooler door in the unlocked position;

FIG. 5 is an enlarged, perspective view of a door lock mechanism;

FIG. 6 is an elevated, perspective view of a card reader;

FIG. 7 is an exploded view of the card reader of FIG. 6; and

FIG. 8 is a flow diagram of a method of the present invention.

### DETAILED DESCRIPTION OF THE PREFERRED EMBODIMENTS

The present invention is a door locking system with identification verification that can read a barcode, magnetic strip, or other indicia on a state driver's license, military identification card, passport or the like, and confirm that the presenter is of legal age to purchase certain products controlled according to local, state, and federal regulations. The present invention is mountable to any surface, such as a cooler door or enclosure that protects age restricted products in a convenience store, retail store, gas station, or the like, and works in conjunction with existing or new locking methods to prevent unauthorized access. The system communicates with a database or server to confirm the age of the identification presenter prior to unlocking the doors.

The wireless door locking system and method may be programmable to further restrict access to the products, such as using curfews to control access during certain hours, prevent access to those who are black listed for one reason or another, etc. Data read from the identification can also be saved and stored remotely, and can be accessed for various purposes including marketing purposes. The door locking mechanism may also communicate with, and be controlled by, a computer device such as a tablet, smart phone, laptop, or the like. The computer device can be used to open the locking mechanism from anywhere, including behind the counter of the store. The door locking mechanism can also include a display that can provide instructions for use, advertisements for specials, and various other information to the customer.

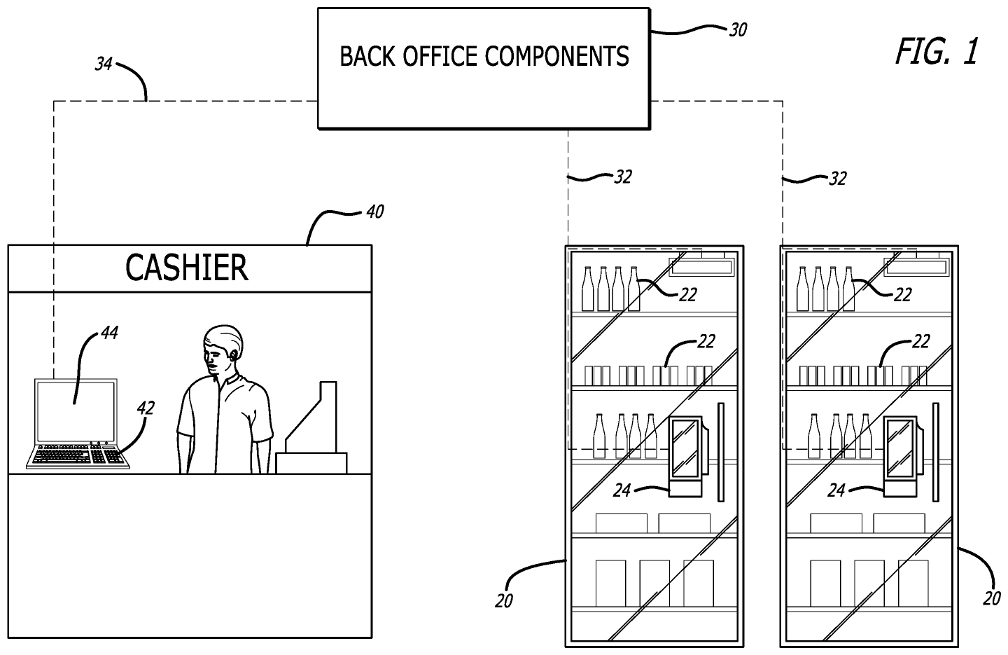

A first embodiment of the present invention is shown in FIG. 1. The figure shows areas of a retail establishment having multiple cabinets 20, a back room 30, and a clerk or cashier station 40. The cabinets 20 store various products 22 that are subject to purchasing restrictions, such as by age. The cabinets 20 are connected to the back room by a connection 32, which may be wired or wireless. The backroom components are connected to the cashier station by another connection 34, which also may be wired or wireless. The cashier station 40 is equipped with a computer device 42, which may be a desktop computer, a laptop computer, a tablet, a smartphone, or the like. The computer device 42 includes a display 44 that is visible to a clerk 46 at the cashier station 40.

The system includes one or more door lock units 24 mounted on the cabinets 20 to control access to the cabinet's interior where the products are displayed and stored. An example of the cabinets 20 would be a refrigerated beer cooler found in liquor stores, gas stations, and minimarts. The door lock units 24 are mounted on the front of the cooler doors, and control a locking device that prevents the door from opening without authorization. These door lock units 24 include a mechanical locking mechanism, an identification scanner/reader, and a display. The mechanical locking mechanism receives power from a power supply that may be located in the back office 30 using a cable to connect the power supply with the locking mechanism.

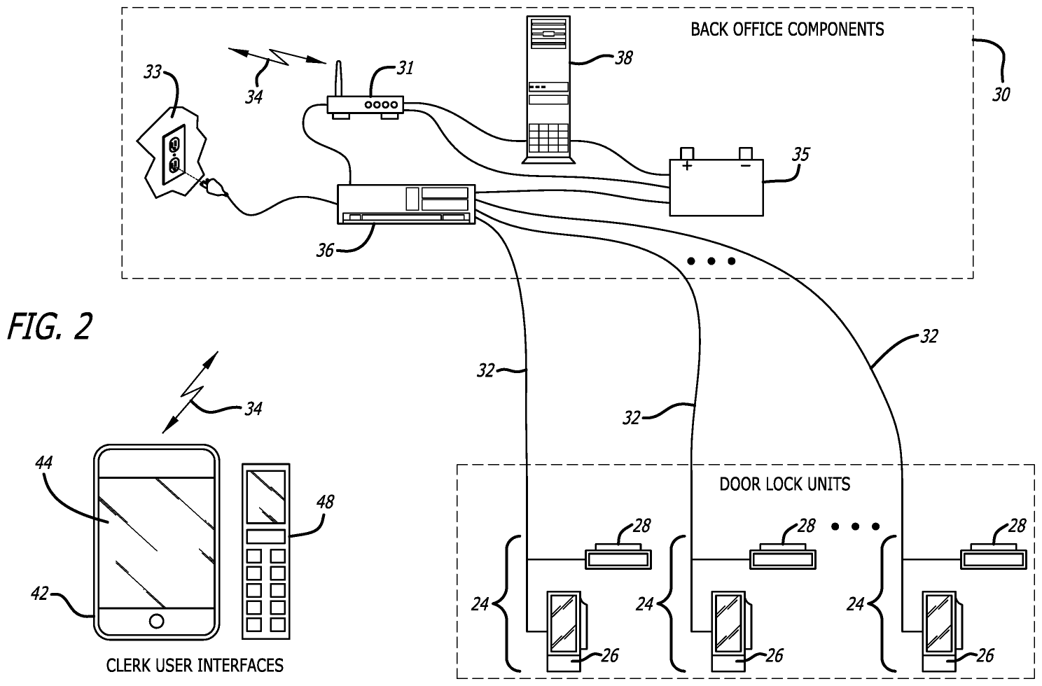

FIG. 2 illustrates the data exchange and power exchange for one preferred embodiment of the present invention. The door lock units 24 include an ID reader 26 and a mechanical door locking mechanism 28. The ID readers 26 are adhesively attached to the front of the cabinet door so that a customer can access the card reader slot on each reader. The customer places the ID in the slot so that the reader can access the magnetic strip, chip, or other data storage device on the ID, and extract the pertinent information. That information is delivered to a computer 36 that receives the information on the customer's ID and verifies that the ID is valid and correct using government databases, private databases, and/or other sources. The computer 36 may access a server 38 where data is stored on various customers, and the computer 36 verifies that the ID is valid and the customer is cleared to purchase the products 22 inside the cabinets 20. A signal is sent to the mechanical locking mechanism 28 to release the lock and allow the door to be opened, whereupon the customer can open the door and remove the products 22.

At the same time, a signal is sent from a transmitter 31 to the computing device 42 at the cashier station 40 that the door has been opened by a customer. The information retrieved on the customer by the reader, such as age, address, photograph, type of identification, is sent to the computing device 42 so that it may be displayed on the display 44. In this manner, the clerk can verify that the customer whose identification is used to open the door is the same customer who purchases the product. Otherwise, a non-verified customer can wait until a verified customer is finished, and grab some product before the door closes. The clerk will be aware of any customer that has been verified, and can reject anyone who does not have authorization to purchase the product. The cashier's station may also include a remote control 48 that can open the mechanical locking mechanisms 28 independently, such as with a customer who is clearly old enough to purchase the product but may not have an identification that can open the door. The remote control may be an RF control, or any other short range or long range communication device that can send a signal to the mechanical door locking mechanisms 28 to open the doors by bypassing the back office components 30.

The computer 36, server 38, and transmitter 31 may all be supported by a power supply 33 and a power back-up supply 35. Power from the power supply 33 may also be used to power the mechanical door locking mechanisms 28 using a cable 32, or the mechanical door locking mechanisms 28 may be powered locally.

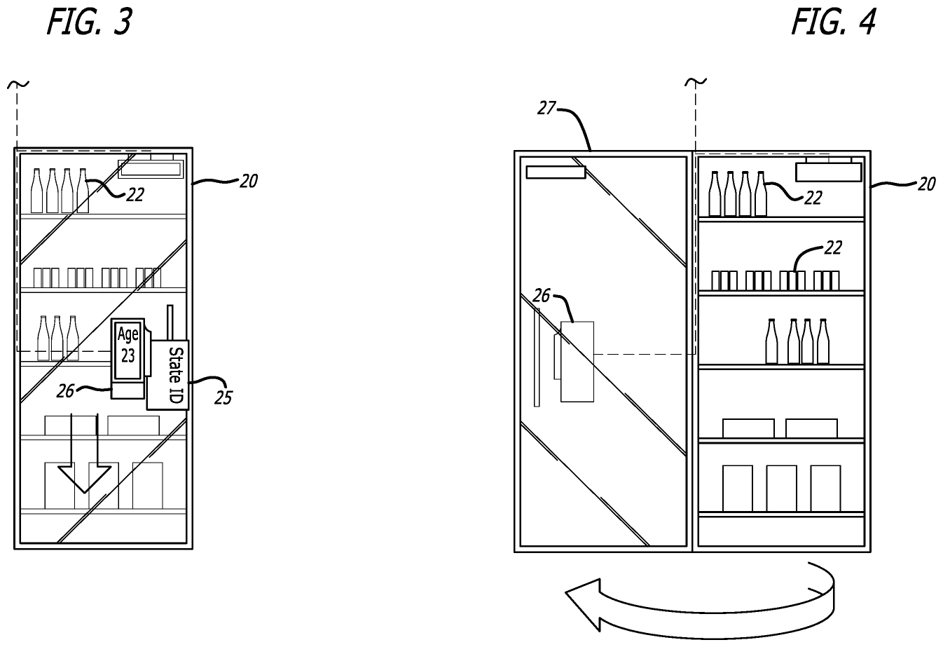

FIGS. 3 and 4 illustrate the operation of the door locking units 24. A customer approaches the cabinets 20 and finds that the doors 27 are locked by the locking mechanisms 28. Instructions on the door 27 or on the reader 26 instructs the customer to swipe, insert, or otherwise allow the reader 26 to read data from a government issued identification card 25. The reader reads the information off of the ID 25, and sends the data to the computer 36 in the back office 30. The computer 36, in conjunction with the server 38 and/or other databases, verifies the age of the customer and sends a signal back to the mechanical locking mechanism 28 to unlock the door 27. The computer 36 also sends a packet of data via a wireless connection 34 to the computing device 42 at the cashier's station 40, where the cashier can view the information on the display 44. When the customer approaches the cashier's station to pay for the product 22, the cashier will have available the customer's photograph, age, and other relevant information to verify the sale of the product. The transaction can then proceed as normal. If the ID is not verified by the computer 36, the door will remain locked and the customer will not be granted access to the cabinet 20. The cashier can override the system with the remote 48 if the cashier deems the situation appropriate to grant access. FIG. 4 illustrates that the locking mechanism 28 has released the door 27 and it is open to permit access to the products 22.

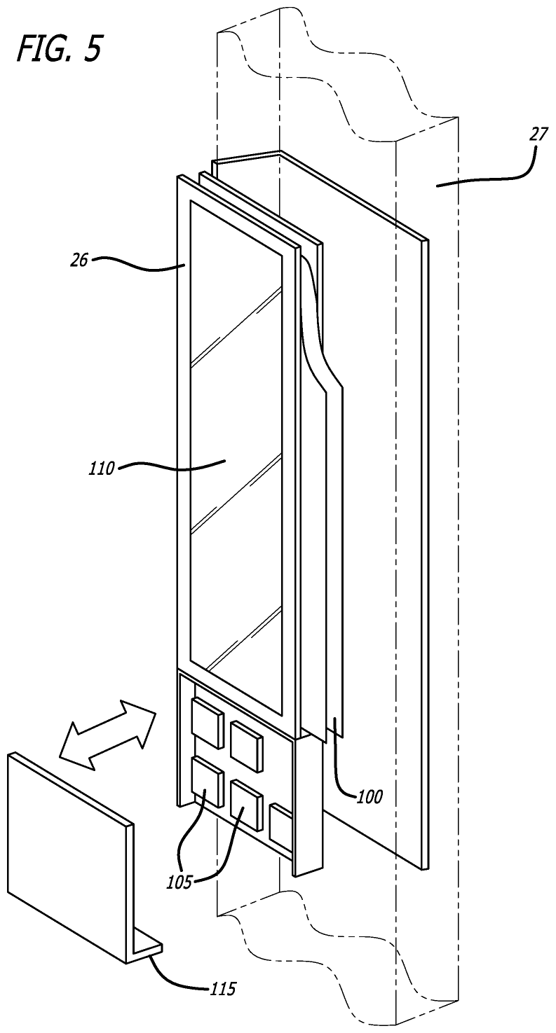

FIG. 5 illustrates a door lock reader unit 26 mounted to a door 27 using high adhesive double sticky tape, although other modes of adhesion is available as well. The reader 26 mounts to the exterior surface of the door so that is can be accessed by the customer, and includes in a first preferred embodiment a longitudinal slot 100 that can read a magnetic strip on a driver's license or other card/ID. The reader 26 extracts the information from the ID and sends the information to the computer 36. The unit may include a series of input buttons 105 that can control on/off, settings, and display features of a display 110. A protective cover 115 shields the input buttons 105 from tampering, and the protective cover may be key locked in some embodiments to prevent unwanted tampering or disablement of the system.

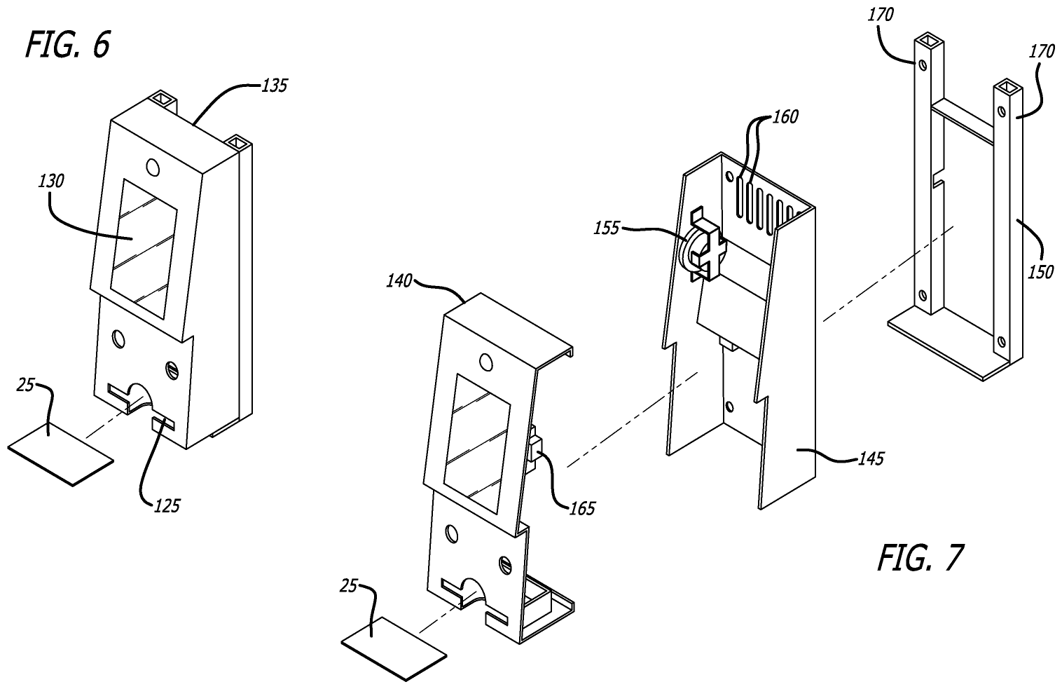

FIGS. 6 and 7 illustrate another housing for the reader 26 that includes a slot 125 for inserting the ID 25. A display 130 provides information, advertisement, and instructions to the customer. The housing 135 is comprised of a front cover panel 140, a back plate 145, and a mounting bracket 150. The housing 135 may include a speaker 155 that can provide audio instructions, sound an alarm, or play advertisements. Cooling holes 160 can allow ventilation to the unit to prevent overheating the processor 165, which also carries the camera or image reading device. The bracket 150 includes columns 170 where cables can be routed to the back office 30 for data or power transmission to and from the device.

The door unit 24 is capable of scanning a user's Driver License or other identification to allow an automated unlock of the door; however, typically the final decision as to whether or not the door should be unlocked lies with the computer 26 or the cashier at the cashier station 40 using the remote control 48.

The door locking unit 24 is mounted to the front of the glass door 27, using adhesive or other mounting means, so that the display is outside the cooler. The cover panel protects the input device and power management, and the display may use an LED or other low power high luminosity device to provide information to the customer.

To implement the software of the door unit 24, a microcontroller such as a Raspberry Pi 3 B+ may be used with a display such as screen with, for example, a five inch, 480×800 panel. The screen has rectangular pixels that may require manual scaling to maintain proper aspect ratio. A camera to scan the customer's driver's license may be a Raspberry Pi Camera User Facing Camera (Face Cam) connected to a USB Web Cam. The unit has an onboard power regulator that can take in up to 17V and produce 5.1V internally, where everything inside the unit operates on 5V. The unit also controls electrical flow to the lock, but the electrical voltage and current to the lock is unregulated. The unit has a scanning light and light controls circuit that's operated by the software.

The main computer 36 is the central control of the system and hosts the code for the various programs used in running the system, including the administrative web user interface or the clerk UI that can be accessed by the store clerk to control access to the products. The main server is supported by a transmitter 31 such as a router, e.g. a WiFi router, so that data may be sent to the clerk's computing device 42. Software written for this invention is summarized below.

Load Settings—On start the settings are loaded from the settings file stored in JSON format inside the app_data/settings.json file.

Discover Locks—On start and at user request the system scans the local network for IDSmartLock Door Units (individual smart locks). In the settings there is a setting called locksNetwork that defines the range of locks to scan. This should not be set manually unless the network structure changes.

Setup Database Access—On start the database access is set up and the database helper library is told the log limit, as defined in the settings.

GET /—Home root for the Clerk UI that lists all the doors.

GET /login—Admin Login page for Clerk UI.

POST /login—Post route to submit login data. It takes in an additional redirect variable so that it can redirect the user to the right screen after a successful login.

GET /logout—Logout route.

GET /admin/locks—Clerk UI screen for editing Door Unit names and positions.

POST /admin/locks—This route takes in as a post request a list of Door Units and their new properties, then updates all of the Door Units individually, and then rescans the network to update the Door Unit list.

GET /admin/locks-refresh—This route triggers a new Door Unit network search and then returns to /admin/locks .

GET /admin/settings—This is the Clerk UI settings screen route. Each of the settings groups are saved individually using their respective POST routes.

POST /admin/settings/curfew—Saves changes to the curfew settings.

POST /admin/settings/general—Saves changes to the general settings such as Door Unit volume, minimum age, etc.

POST /admin/settings/password—Updates admin password.

POST /admin/settings/time—Updates main system time. The system is designed to work without a network connection, so this function covers manually setting the time.

GET /admin/blacklist—Show the Blacklist screen in the Clerk UI.

GET /admin/logs—Show the Logs screen in the Clerk UI.

GET /api/logs/:limit/:offset—This is the route used by the Clerk UI to load more log items without having to reload the page. It returns new items in JSON format that's then added to the DOM of the page on the fly.

GET /api/blacklist/:key—API call fired by the Clerk UI to add a given unlock event to the blacklist. We add events instead of people to the blacklist so that the blacklisting record could contain the photo of the convenience store customer at the time the blacklist decision was made.

GET /api/blacklist-remove/:dln—API call fired by the Clerk UI to remove a customer from the blacklist based on their driver license number.

GET /api/door/:call/:ip—This is a catch all function that will forward the unlock, lock, disable, and enable requests from the Clerk UI to the individual Door Units.

Because of some issues with the HTML and use of dots in the HTML ID names, we use dashes instead of dots in the Door Unit IDs (which are also IP addresses of the Door Units), and convert between the 2 formats.

GET /api/door-ajar/remove—Route to remove a Door Unit from the list of ajar doors. This is called by the individual Door Units.

POST /authorize-unlock—This is the route called from the Door Unit to authorize and log an individual unlock request. The system verifies that the system is not in curfew, that all of the information was passed to the Main Server successfully, and that the individual customer is not blacklisted and is of proper age. After this, the system responds with an authorization response and logs the event in the database.

GET /ping—This route is constantly (every few seconds) called from the Clerk UI. It responds with current Main Server time and status of ajar doors, if any. We use this to communicate with the Clerk UI about system uptime and ajar doors.

GET /curfew—This route is called by the individual Door Units to check on the system curfew status. This avoids having to maintain accurate system time on each of the Door Units individually, as it is the central system that decides when the curfew is enacted.

GET /curfew-test—Test route used exclusively for development.

GET /password-reset—Route for resetting the password in case it is forgotten. To reset the password the user would need to know the server secret (defined in the app_data/settingsjson file under serverSecret).

authentication.js—This code handles token based authentication for the main server and contains the express middleware function for restricting access to administrative functions. The authentication method uses the server secret and encrypts it along with a time token. The encrypted token is sent as a cookie to the Clerk UI browser.

curfew.js—This code handles all of the complex curfew function logic. The system makes the assumption that if the curfew is defined as being from, say, 5 PM to 7 AM on Fridays, that in fact the curfew will be from 5 PM Friday to 7 AM Saturday morning.

db.js—This code handles all of the SQLight database functions.

locks.js—This code is used to discover new Door Units on the system, store their names and positions, and maintain the ajar door states.

settings.js—This code handles saving and retrieving settings from the app_data/settings.json file.

utility.js—This code houses some unrelated functions that need to be shared with many different parts of the app. It includes the following functions:

log (function)—Used to write pretty logs for server event logging.

dobToAge (function)—Used to calculate age for a person given their DOB. This is a surprisingly difficult task given all of the leap years, time shifts, and time zones.

app_data—Folder containing all of the app data files.

data.db—Main SQLite database used to store event logs and blacklist.

CREATE TABLE “blacklist” (“dln” TEXT NOT NULL UNIQUE, “name” TEXT, “dob” TEXT, “pic” BLOB, PRIMARY KEY(“dln”))

CREATE TABLE “log” (“key” INTEGER PRIMARY KEY AUTOINCREMENT UNIQUE, “name” TEXT, “dln” TEXT, “dob” TEXT, “time” INTEGER NOT NULL, “lock” TEXT NOT NULL, “type” INTEGER NOT NULL, “pic” BLOB).

settings.json—Main settings file.

serverPort—Main Server Port, set to 8080 by default.

locksPort—Door Unit Port, set to 8080 by default.

locksNetwork—The IP of the network where the main server will search for Door Units. The X indicates the portion of the IP that will be searched.

adminPass—An encrypted version of the admin password.

adminLoginTimeout—Timeout, in minutes, for how long the admin should stay logged in.

serverSecret—The secret passphrase that is used to encrypt the admin password. This should be changed on every individual customer installation.

curfew—Curfew settings.

doorChimeVolume—Volume for the Door Unit.

historySize—How many unlock events the server should save on the database. 0 means store everything.

doorRelock—Door re-lock timeout in seconds.

doorAjar—Door ajar timeout in seconds.

minAge—Minimum drinking age setting.

views—Folder containing all of the files for the Clerk UI that runs in the Web Browser on a tablet.

admin-blacklist.ejs—Blacklist screen of the Clerk UI.

admin-locks.ejs—Door Unit rename screen of the Clerk UI.

admin-logs.ejs—Log screen of the Clerk UI.

admin-settings.ejs—Settings screen of the Clerk UI.

home.ejs—Main screen of the Clerk UI.

login.ejs—Login screen of the Clerk UI.

partials—Folder containing partial views.

head.ejs—Top portion of every Clerk UI screen.

tail.ejs—Bottom portion of every Clerk UI screen.

public—Folder containing CSS and JS files imported by the HTML (EJS) pages above. js/main.js—Main user JS file. The app was designed to offload most of the logic to the Main Server for better security and performance, but some of the UI logic has to be run in the web browser for better user experience (UX). This code is responsible for dynamically loading additional log items, sending unlock and re-lock API requests to the individual Door Units through the Main server, and for periodically (every few seconds) pinging the Main Server for updates.

Supporting Files

app.sh—Bash script used to start the server.

IDSmartLock.service—SystemD Service file that allows the Main Server to be started at system boot and restarted on failure. This file is symbolically linked to /etc/systemd/system/IDSmartLock.service.

pwd-reset.js—standalone script for resetting passwords.

App.py—Main Door Unit app file that starts the GUI and the Server Threads. In this file on line 17 the IP of the main server is defined. This must be set properly for the GUI to be able to request unlocks (self.doorClient). Because the system will be operated on a dedicated IP network this shouldn't be need to be reset in the future, and as a result was not made to be a separate setting.

DoorState (class)—This is a shared class that we pass to every other main object in the app. The 3 main threads talk to each other by writing and reading the properties of the object instantiated from this class.

Cron (class)—This is the third thread, in addition to the GUI thread and the Server thread. Cron runs outgoing server communication tasks periodically (set to 15 second sleep between runs). By removing the outgoing server tasks from the GUI thread we eliminated a significant source of jank (UI stutters) at a cost of increased complexity. Curfew status is checked here.

DoorUnitGUI.py—The Door Unit GUI in TKInter. This file contains all of the GUI code and pulls in other libraries for additional functionality. The different GUI screens are PNG images. The images were designed at the resolution of 640×1080 and scaled to 480×800. The images have to be manually scaled because the logical aspect ratio of the screen doesn't exactly match physical aspect ratio (pixels are not square).

DoorUnitGUI (class)—This is the wrapper class for TKDoorGUI that loads an instance of that class into TKInter and also handles the following functions:

mainLoop (function)—This starts the TKInter's main loop. For some reason it just wouldn't work with the Threading regular run function.

cron (function)—Here we handle things that have to be checked for all the time. This function is set to run every 500 ms. We check here if the fridge has entered disabled mode by checking with the shared library, and we check the hardware state of the lock to determine if the fridge is now open. This is mainly to respond to main server events.

Hardware UI Buttons—GPIO Code for the buttons is defined here, but triggers the functions defined inside the TKDoorGUI class.

TKDoorGUI (class)—Here we do all of the GUI stuff and business logic. The GUI in this project did not require direct interaction via screen elements because the program is designed to be interacted exclusively through the use of front hardware buttons (operated via GPIO) and server instructions. The GUI logic is generally limited to loading and unloading screen layouts in .png image format and overlaying additional user interface elements. Each screen is loaded by a function named after that screen. Extensive use of TKInters after command was used to load various sound effects in a somewhat asynchronous manner to eliminate as much as possible the UI jank.

UIScreen (Enum Class)—Helper class defined at the bottom of the file to store UI screen locations.

DoorUnitServer.py—The Door Unit Server that listens for event calls from the main server and reacts to them. All of the HTTP server logic is actually in the DoorUnitLib.py file due to early decision to separate code bases in such a way that one team could work on all of the HTTP API logic and another team can work exclusively on the GUI logic. While in the end this was not an approach we used, it's still a good decision for future maintainability of the codebase.

DoorUnitServer (class)—This class loads and updates door related settings such as door name and door position. These settings are stored on the individual locks, rather than the server, to maintain robustness of the system. This way, even in the event that lock hardware ID or IP number changes, the lock can still maintain its assigned name and position in the list of locks on the main administrative UI. This class also handles manual unlocks, locks, and disable and enable events sent by the main server.

Libraries

DoorHWLib.py—This library controls all of the HW functions and uses the hardware state of the door lock and the door ajar switch to determine if the door is ajar or not. It also controls the physical buttons and lights of the door unit, but NOT the cameras.

DoorUnitLib.py—This is the library for interacting with the main server. It has 2 classes, DoorClient and DoorServer.

DoorServer (class)—This class is responsible for serving the door API that allows other machines on the network to interact with the door. It is used at the moment exclusively to allow the main server to control the Door Unit.

DoorClient (class)—This class contains functions for checking door lock settings set by the server, curfew times, to authorize an automatic unlock, and to inform the main server of a door ajar event.

BarCodeLib.py—Library that takes photos of the Driver Licenses and returns the PDF417 barcode data. The file contains BarCodeLib class that houses the following 2 important functions.

scan (function)—This function takes a picture of the user's Driver License using the Raspberry Pi Camera and returns text extracted from the PDF417 2D barcode on the back of the driver license. This function must be prepended by the prepare function. Logic inside the prepare function initiates the HW camera. Because the camera needs a few milliseconds to warm up before it can take a picture, to avoid UI jank, the prepare function was designed to be ran a bit before the scan function. The scan function attempts the fast mode of the zxing library at first. If it fails, it falls back to the slow mode. That usually covers 80% of cases. In case of failure to extract data it falls back to advanced mode. In advanced mode the software rotates the image to the left and the right in 1° increments (up to 10°) until the barcode is found. After the scan procedure is finished, if no rescans are desired, it is very important to run the finish function to unload the camera. This will prevent the camera from being damaged as a result of overheating.

read (function)—This function is responsible for taking the text data produced by the scan function and extracting fullName, dob, dln, state, and expiration from the text. For additional information please see Appendix B on Driver License Barcode Data Extraction.

FaceCamLib.py—The library for taking pictures from the face cam on the front of the Door Unit. The library returns a binary buffer in JPG format of the picture as well as the same in Base64 encoding. The Base64 copy is used for submitting the image to the server in an HTTP request and is stored directly as a string in a database. The library uses OpenCV2 to interact with the face cam.

SoundLib.py—This library relies on amixer and aplay Linux system utilities. It has a function for playing a sound and for setting the volume output of the system. This was necessary because standard Python sound libraries rely on desktop GUI systems, such as Gnome or KDE, to provide the sound subsystem. Such was not available to us because we are running the Door Unit program directly on top of Xorg. A decision was made to avoid standard desktop subsystems to reduce system resource load and significantly improve system boot times and reliability of the overall system.

lib/zxing—ZXing C++ library and its source code used to read the RAW data from the PDF417 barcodes on the back of a Driver License. This is an open source library written in C++ and compiled with Python bindings.

Setting Features:

Banning feature: This feature allows a store to ban any ID from access in the future.

Master password: Create master password to make custom changes.

Age setting: This feature allows a store to set the desired age on each door for access.

Volume control: This setting allows a store to set the volume on both door and counter unit.

Curfew setting: This feature allows a store to set the curfew on each door for any day or time of the week, including days that certain states don't allow alcohol to be sold.

Remote access feature: This feature allows the clerk or staff members to access the cooler doors remotely anywhere in the store up to 100 feet directly from the tablet.

Door ajar settings: This setting allows you to set the amount of time that it takes to notify the employee if the door has been left open or is ajar, Settings may range from 5 to 30 seconds.

Among the capabilities of the present invention is the ability to collect information such as times when the doors were opened, the ages of the customers who opened the door, the gender of the customers who opened the door, their zip codes, and other personal information. The door lock unit's display can also promote or advertise store specials, local events, or special pricing on certain products in the store. The data can be accessed anywhere in the world via any smart device or computer, giving proprietor the ability to see the history of each door or monitor in real time events as they happen, make changes within the location where the products are located, and acquire data as needed using a cloud based system. The system also allows a user to capture images and/or video and forward data via email, text, etc. information to police, suppliers, or other remote locations. In some cases, customers can be black listed across several stores where information is shared or distributed to the retail community.

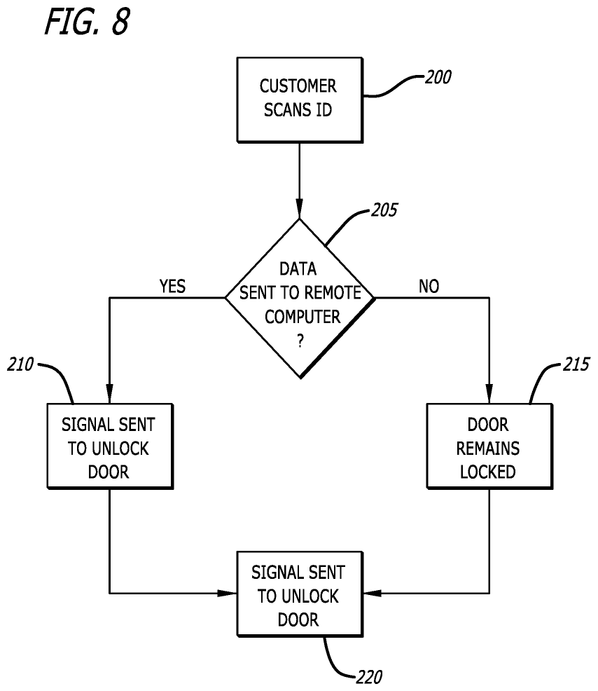

In operation, the system and method (FIG. 8) of the invention works as follows. Customers of legal drinking age may walk up to a cooler door of their choice and scan their state issued ID or Driver's license into the ID Smart Lock (step 200). In some embodiments, the customer presses the scan button, the door lock unit 24 takes the customer's photo. The system then audibly and textually/graphically provides instructions to press the confirm ID button. The information received from the ID is forwarded to the computer 36 in the back office (step 205), where it is evaluated against known databases for verification, holds, blocks, and restrictions. If the customer is of legal drinking age and no impediments are present, the computer 36 sends a signal to the mechanical door locking mechanism to unlock the door 27 (step 210), and the door automatically unlocks. If the computer determines that the customer is not permitted to gain access to the cabinet 20, the door remains unlocked (step 215). The outcome of the decision is sent to the computing device 42 monitored by the cashier so that the cashier is aware of the status. The whole process takes less than a few seconds. After the door unlocks, the system immediately sends the customer's photo and ID information to the display 44 of the computing device 42, which may be a dedicated tablet or smart device located behind the counter where an employee can match and confirm the customers identity and age prior to sale.

The foregoing descriptions and depictions are intended to be exemplary and not limiting as far as the present invention. There may be many variations of the presently described systems that are properly considered part of the present invention. Various changes that would be readily apparent to a person of ordinary skill in the art are intended to be part of the invention, and nothing in the drawings or description is intended to be limiting except where expressly designated.

I claim:

1. A validation system for a retail establishment for gaining access to a secured area, the system comprising:
a door locking unit mounted exterior to the secured area, the door locking unit including a customer identification data extracting device for extracting data from a customer identification, and a door locking mechanism;
a remote computer connected to the customer identification data extracting device by a data exchange bus for receiving information extracted from the customer identification, the remote computer configured to verify a datum of extracted information determinable for permitting access to the secured area;
a computing device wirelessly communicating with the remote computer for displaying extracted customer data to a user;
whereby the remote computer sends a signal to the door locking mechanism to unlock the door upon verification of the datum of extracted information.

2. The validation system of claim 1, wherein the datum is an age of the customer.

3. The validation system of claim 1, wherein the door locking unit is mounted to a door of the secured area.

4. The validation system of claim 3, wherein the secured area is a cooler storing alcoholic beverages.

5. The validation system of claim 4, wherein the door locking unit is mounted using two sided adhesive tape.

6. The validation system of claim 1, wherein the door locking unit and the remote computer are powered by a common power source.

7. The validation system of claim 1, wherein the door locking unit is connected to the remote computer using a cable.

8. The validation system of claim 1, wherein the customer identification is a state driver's license.

9. A method for controlling access to a secure area in a retail establishment, the method comprising:
providing a remote controlled door lock on a door of the secure area;
providing a customer identification reader exterior to the secure area;
providing a computer having access to a database for valid customer identifications;
reading a customer identification;
transmitting data extracted from the customer identification to the computer;
comparing the data extracted from the customer identification with the database to verify a datum of the customer identification;
sending a signal from the computer to the remote door lock to open the door if the computer determines that the datum is verified; and
sending customer information to a remote computing device where the customer information can be read by a user.

10. The method of claim 9, wherein the secure area is a liquor storage unit.

11. The method of claim 10, wherein the datum is an age of the customer.

12. The method of claim 11, wherein the computer sends a photograph of the customer to the remote computing device.

13. The method of claim 11, wherein the customer identification reader reads state driver's licenses.

14. The method of claim 11, wherein the customer identification reader includes a speaker.

15. The method of claim 11, wherein the computer accesses a local server storing information on state driver's licenses.

16. The method of claim 11, wherein the customer identification reader includes a display for communicating with a customer.

17. The method of claim 14, wherein the speak can transmit audible instructions to a customer.

18. The method of claim 11, wherein the remote computing device is a handheld device monitored by a cashier.

19. The method of claim 11, wherein the computer sends a signal to the remote computing device when a determination has been made that the customer identification is not verified.

20. The method of claim 11, wherein one aspect of a verification process is ensuring the customer is not on a restricted customer list.
